(19) United States
(12) Patent Application Publication
(10) Pub. No.: US 2026/0248070 A1
(43) Pub. Date: Aug. 27, 2026

(54) GROUNDS MAINTENANCE VEHICLE WITH MODIFIED CUTTING MECHANISM

(71) Applicant: ELECTRIC SHEEP ROBOTICS, INC., Harleysville, PA (US)

(72) Inventor: Naganand MURTY, Alamo, CA (US)

(73) Assignee: ELECTRIC SHEEP ROBOTICS, INC., Harleysville, PA (US)

(21) Appl. No.: 19/128,528

(22) PCT Filed: Nov. 8, 2023
(86) PCT No.: PCT/US2023/037037

§ 371 Date: May 8, 2025

(51) Int. Cl. A01D 43/08; A01D 101/00; G05D 1/622; G05D 1/648; G05D 107/20; G06V 10/764; G06V 20/58

(52) U.S. Cl. CPC A01D 43/085; G05D 1/622; G05D 1/648; G06V 10/764; G06V 20/58; A01D 2101/00; G05D 2107/23

(57) ABSTRACT

A machine includes a suction motor configured to generate suction for objects on ground so as to raise the objects through a cutting plane above and separated from the ground. A flexible cutter is configured to cut and/or shear the raised objects along the cutting plane. The cutter is coupled to a cutting motor separate from the suction motor. A housing is configured to cover the cutter while exposing the cutter towards the ground to enable cutting of the raised objects. A chamber is coupled to the housing and disposed above the cutter. The chamber is separated from the cutter and includes a secondary blade configured to grind portions of the raised objects cut by the cutter into a residue. The suction motor is coupled to the housing and the chamber, and disposed such that the suction generated therefrom directs the cut portions of the raised objects into the chamber.

### CROSS-REFERENCE TO RELATED APPLICATIONS

The present application claims the benefit of priority to U.S. Provisional Patent Application No. 63/423,673, filed on Nov. 8, 2022, the entirety of which is incorporated herein by reference for all purposes.

### TECHNICAL FIELD

The present application relates generally grounds maintenance vehicles and in particular to grounds maintenance vehicles with a modified cutting mechanism for improves safety.

### BACKGROUND

Robots are being used perform many tasks traditionally performed by humans. One example of such tasks is grounds maintenance. However, when direct supervision by human operators is not available, the robots used for grounds maintenance need to be capable of achieving comparable, if not superior level of safety, efficacy, efficiency that is provided by a human operator's oversight. Consequently, for an autonomous grounds maintenance vehicle to be able to achieve the same levels of safety a few design modifications to traditional grounds maintenance vehicles such as, for example, lawnmowers, may be desirable.

### SUMMARY

In one aspect of the present disclosure, a machine for grounds maintenance may include a suction motor configured to generate suction for objects on ground so as to raise the objects through a cutting plane above and separated from the ground. A flexible cutter is configured to cut and/or shear the raised objects along the cutting plane. The cutter is coupled to a cutting motor separate from the suction motor. A housing is configured to cover the cutter while exposing the cutter towards the ground to enable cutting of the raised objects. A chamber is coupled to the housing and disposed above the cutter. The chamber is separated from the cutter and includes a secondary blade configured to grind portions of the raised objects cut by the cutter into a residue. The suction motor is coupled to the housing and the chamber, and disposed such that the suction generated therefrom directs the cut portions of the raised objects into the chamber.

Additional features and advantages of the subject technology will be set forth in the description below, and in part will be apparent from the description, or may be learned by practice of the subject technology. The advantages of the subject technology will be realized and attained by the structure particularly pointed out in the written description and embodiments hereof as well as the appended drawings.

It is to be understood that both the foregoing general description and the following detailed description are exemplary and explanatory and are intended to provide further explanation of the subject technology.

### BRIEF DESCRIPTION OF DRAWINGS

FIG. 1 shows a schematic of a grounds maintenance machine including a slowing or stopping feature in accordance with some embodiments of the present disclosure.

FIG. 2 shows a schematic of a modified cutting mechanism in accordance with some embodiments of the present disclosure.

FIG. 3 shows a schematic of an alternate modified cutting mechanism in accordance with some embodiments of the present disclosure.

### DETAILED DESCRIPTION

Safety can generally be defined as not causing harm to the environment or living beings in the environment. In the context of grounds maintenance, when objects are deemed by a human operator as non-obstacles in the plane of grass, the human operator will avoid or deliberately run over non-grass obstacles that a mower may encounter in its path in the process of mowing. In contrast, for objects deemed as obstacles, the human operator will stop and/or avoid such objects. For instance-a human operator may choose to run over leaves, while choosing to stop and avoid hitting branches above a certain size. Similarly, the human operator will avoid hitting large above-grass objects such as benches, people, dogs, etc. In addition, the human operator will also stop to clear the area of any objects that may become projectiles as they hit the spinning blades, and get launched into the air.

An autonomous grounds maintenance machine such as a lawnmower should achieve similar (or better) outcomes. Some of the design modifications that may allow an autonomous grounds maintenance machine, such as for example, an autonomous grounds maintenance vehicle, to achieve human-comparable safety are described herein. It should be noted that while the description that follows may use a lawnmower as an example of a grounds maintenance machine, one of ordinary skill in the art, upon understanding of the present disclosure, will be able to apply the principles described herein to other grounds maintenance machines. Examples of grounds maintenance machines include, but are not limited to, lawnmower, hedge trimmer, string trimmer, tiller, cultivator, weed puller, pole saw, leaf blower, chain saw, hedge shears, pesticide sprayer, snow blower, snow remover, or any other tools suitable for landscaping and/or property maintenance.

Further, it will be understood that functioning autonomously does not necessarily mean functioning fully autonomously without any human supervision or support. In other words, functioning autonomously as used herein does not refer only to Level 5 automation. Thus, an autonomously operated grounds maintenance machine in accordance with some implementations of the present disclosure can function autonomously; however, a human user, if necessary, can override the autonomous control of vehicle and control it locally or remotely.

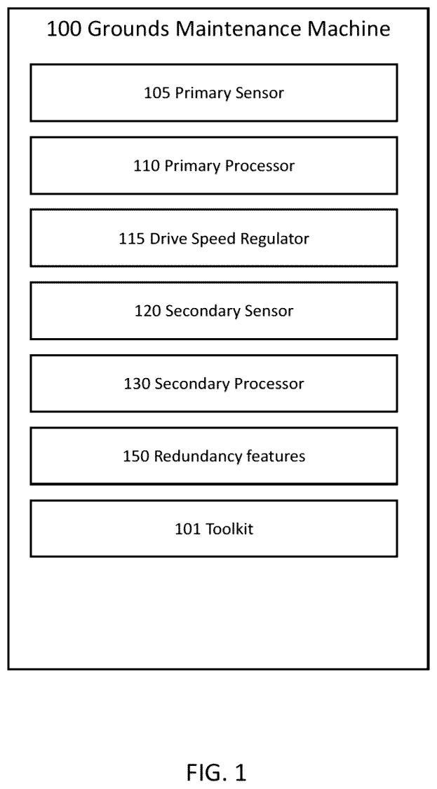

One of the safety features that can be added to a grounds maintenance machine includes slowing or, if needed, stopping the machine. FIG. 1 shows a schematic of a grounds maintenance machine including a slowing or stopping feature in accordance with some embodiments of the present disclosure. The grounds maintenance machine 100 is provided with a toolkit 101, a primary sensor 105, a primary computing device 110, a drive speed regulator 115, a secondary sensor 120, a secondary computing device 130, and one or more redundancy features 150.

The toolkit 101 may include one or more tools or actuators enabling the grounds maintenance machine 100 to perform its functions. For example, the toolkit of a lawnmower may include one or more set of blades structured and positioned for cutting grass on the ground within a property being maintained. The toolkit of a lawnmower may also include a suction motor for sucking up cut grass and other debris, a container or a basket for collecting the sucked up grass and other debris, a hose for connecting the suction motor to the container or basket, as well as other tools generally suitable for a cutting and/or shaping grass on the ground.

The primary sensor 105 may include one or more sensors such as a camera, an ultrasound sensor, a radar, a LIDAR, etc. These sensors are configured to sense physical characteristics of the environment in and around the immediate and upcoming path of the machine 100.

The primary computing device 110 (also referred to herein as the primary processor 110) may include one or more processors such as one or more motion processing units (MPUs), digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an MPU and a microprocessor, a plurality of microprocessors, one or more microprocessors in conjunction with an MPU core, or any other such configuration.

In some embodiments, the primary processor 110 processes data received from the primary sensor 105 to navigate and operate the machine 100. The primary processor 110 is configured to receive and process data from the primary sensor 105 and determine whether a detected object is an obstacle. If an object is deemed to be an obstacle, the primary processor 110 may further determine whether the machine should reduce its speed and/or stop, or continue to run. The primary processor 110 then generates corresponding instructions and transmits the instructions to the drive speed regulator 115.

The drive speed regulator 115 regulates the speed of the motor driving the machine 100 and may typically include electronic circuits in combination with sensors such as wheel encoders, optical flow sensors, and the like. The drive speed regulator 115 senses the speed of the machine 100 and sets the speed of the drive motor as commanded by the primary processor 110.

The secondary sensor 120 may include sensors such as ultrasound sensors, cameras, radar, LIDAR, etc., in addition to the primary sensor 105. Like the primary sensors 105, the secondary sensors 120 also sense the physical characteristics of the environment in and around the immediate and upcoming path of the machine 100 and transmit the results to the secondary computing device 130 (also referred to herein as the secondary processor 130).

The secondary processor 130, in combination with the secondary sensor 120, act as redundancies for the primary sensor 105 and the primary processor 110. Thus, the secondary processor 130 processes the data received from the secondary sensor 120 to determine whether a detected object is an obstacle. If, for example, a detected objected is deemed to be an obstacle, the secondary processor 130 determines whether the machine should continue or reduce its speed and stop. The secondary processor 130 then generates corresponding instructions and transmits the instructions to the drive speed regulator 115.

In some embodiments, the secondary processor 130 and the primary processor 110 are physically distinct processors. In some embodiments, the primary processor 110 and the secondary processor 130 may be implemented on the same piece of hardware or software. Thus, like the primary processor 110, the secondary processor 130 may include one or more processors such as one or more motion processing units (MPUs), digital signal processors (DSPs), general purpose microprocessors, application specific integrated circuits (ASICs), application specific instruction set processors (ASIPs), field programmable gate arrays (FPGAs), or other equivalent integrated or discrete logic circuitry.

In some embodiments, the redundancy features 150 include, but are not limited to, separating the primary and secondary sensors and processors and have each perform the corresponding tasks in parallel. In such embodiments, the instructions to the drive speed regulator 115 may be provided only a concurrent input from the primary and secondary processors. Further, a slower of the two drive speed inputs may be used for regulating the drive speed.

In some embodiments, while the sensing of the environment surrounding the machine may be performed independently by the primary and secondary sensors, the processing of the collected data may be performed concurrently. In such embodiments, a data agreement check may be performed by the computing device (which implements both the primary and secondary processors). Thus, for example, in case of an agreement in the data, the drive speed regulator provided with the consensus instructions (e.g., do nothing, reduce speed, or stop). On the other hand, in case of a disagreement, the drive speed regulator is instructed to immediately stop the machine.

In some embodiments, other redundancy features such as an immediate stop feature that can bring the machine to a complete stop within a predetermined amount of time such as, for example, 100 ms, may be included. The immediate stop feature can be realized by providing the machine with a sensor (referred to herein as a bump sensor) that can sense that the machine has bumped into an object. Examples of bump sensors include limit switches that react to a collision with an object). Upon sensing that the machine has bumped into an object, the information is transmitted to the primary and secondary processors which will generate a stop command to the drive speed regulator.

In machines such as lawnmowers that include a cutting object such as a blade, a blade speed regulator may additionally be included as a redundancy feature. In some embodiments, the blade speed regulator is configured to regulate the speed of the motor driving the blade. The blade speed regulator may sense the speed of the blade and set the speed based on the instructions received from the primary and/or secondary processor. In some embodiments, the blade speed regulator comprises a current cut-off relay circuit.

Some embodiments may include a brake that can physically stop the motion of the drive motor (and in embodiments with a blade, of the blade motor). In some embodiments, the brake may be implemented as an electro-hydraulic valve placed in-line with the hydraulic lines of the drive motor (and in embodiments with a blade, of the blade motor) that will arrest the flow of the hydraulic fluid to the corresponding motor. In some embodiments, where the drive (and/or blade) motor is an electric motor, the brake may be implemented as a circuit that applies a reverse current to the electric motor. In some embodiments, where the drive (and/or blade motor) is coupled to an internal combustion engine, the brake may be implemented by cutting off electric supply to the spark plugs of internal combustion engine.

To obtain further redundancy the sensors (primary and/or secondary) may include tilt sensors to measure inclination of the machine and differentiate between the inclination of the ground and the inclination of the machine. Additional redundancy sensors may include blade load sensors configured to differentiate between normal load on the blades and abnormal load on the blades, e.g., in cases where the blade is pushing against an object deemed to be an obstacle. In such embodiments, the primary and/or secondary processors are configured to generate a slow or stop instruction in response to sensing of abnormal load on the blades.

In certain implementations of grounds maintenance machines such as, for example, lawnmowers, the safety features described herein may require further redundancy or modification to eliminate safety risks.

A typical lawnmower is required to perform three separate tasks-(a) generate suction to make the grass stand tall so it is perpendicularly aligned to the direction of the cutting blade; (b) cut or shear the blade of grass using a cutter such as, for example, a disc blade, a rotary blade, a reciprocating shear, and the like; and (c) collect the cut portions of grass. The collected cut grass is typically bagged to be disposed off or mulched to a fine residue and left behind on the ground. While the bagging process is laborious, the mulching process may lead to residual clumps which are not only unsightly but also have the potential to damage the grass by blocking sunlight from the underlying grass.

The rotary blade mechanism of a traditional lawnmower typically performs all the three tasks (a)-(c). A single motor turns the rotary blade at a speed high enough to: (a) create the suction; (b) cut the grass standing tall from the ground because of the suction; and (c) mulch the grass by creating turbulence that keeps the cut portions of the grass in the air long enough to get cut by the blade multiple times. However, the high speed and rigid nature of the rotary blade create safety risks, in particular, for autonomously operated lawnmowers in case of a sensor malfunction. Thus, further mitigate the safety risk posed by the single-rotary blade design lawnmowers, the inventors of the present application designed a modified cutting mechanism.

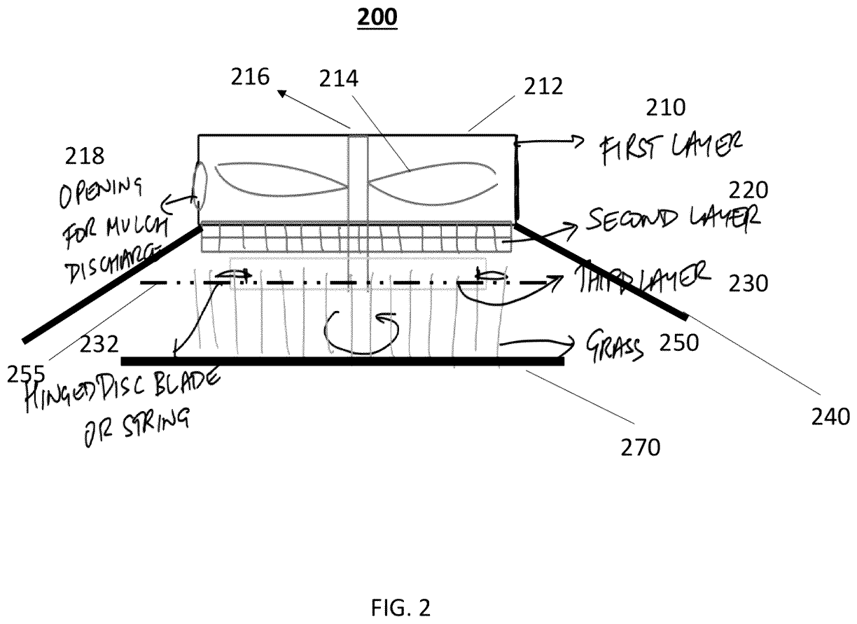

The modified cutting mechanism is provided by separating the three tasks involved in lawnmowing. FIG. 2 shows a schematic of a modified cutting mechanism in accordance with some embodiments of the present disclosure.

Accordingly, in some embodiments, a machine may include a suction motor 216 configured to generate suction for objects on the ground so as to raise the objects 250 through a cutting plane 255 above and separated from the ground 270. A flexible cutter 232 is configured to cut and/or shear the raised objects 250 along the cutting plant 255. The cutter 232 is coupled to a cutting motor separated from the suction motor 216. A housing 240 is configured to cover the cutter 232 while exposing the cutter 232 toward the ground 270 to enable cutting of the raised objects 250. A chamber 210 is coupled to the housing and is disposed above the cutter 232. The chamber 210 is separated from the cutter 232 and includes a secondary blade 214. The secondary blade 214 is configured to grind the portions of the raised objects 250 cut by the cutter 232 suctioned into the chamber 210 into a residue. The chamber 210 is configured to contain the residue. The suction motor 216 is coupled to the housing 240 and the chamber 210 and is disposed such that the suction generated by the suction motor 216 directs the cut portions of the raised objects 250 into the chamber 210.

In embodiments where the machine is a lawnmower, the objects 250 include blades of grass to be cut. However, the objects are not limited thereto. For example, the objects may include leaves on the ground which can be suctioned up to the cutting plane 255 to enable cutting or shearing thereof by the flexible cutter 232.

In some embodiments, as shown in FIG. 2, the suction motor 216 may be coupled to the secondary blade 214. In such embodiments, the suction motor 216 drive the secondary blade 214 and the rotation of the secondary blade 214 generates the suction to raise the objects 250 on the ground 270 into a vertically aligned position.

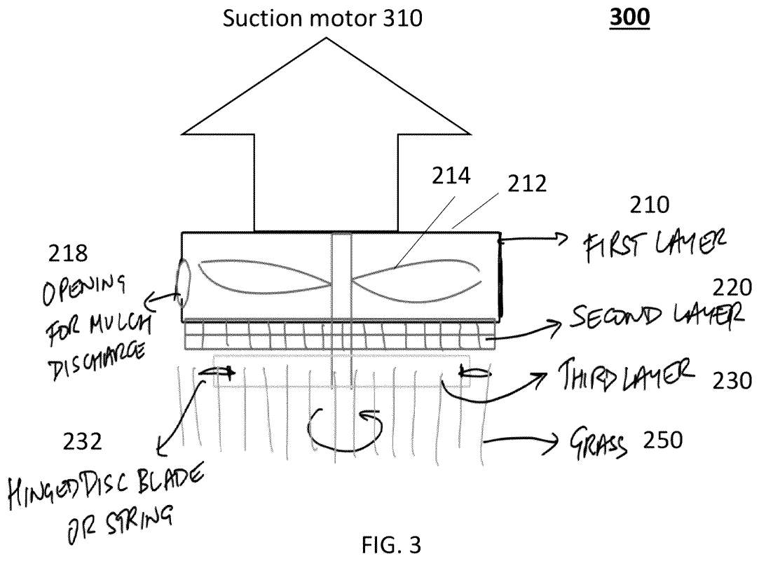

However, the configuration of the machine is not limited thereto. For example, as can be seen in FIG. 3, the suction motor 310 may be separate from the motor driving the secondary blade 214. In some embodiments, as seen in FIGS. 2 and 3, the motor driving the cutter 232 and the secondary blade 214 may be the same; however, the configuration of the machine may be suitably modified such that the suction motor, the motor driving the cutter 232 and the motor driving the secondary blade are different motors. Alternatively, any two or more of these motors can be coupled or provided through a single motor.

In some embodiments, the secondary blade 214 may be a high-lift mulching blade that is configured to create high amount of suction to keep the cut portions of the raised objects 250 (also referred to herein as clippings) in the air for a longer period of time to enable the secondary blade 214 to cut through the clippings several times.

In some embodiments, an inner wall of the chamber 210 may be coated or lined with a non-stick material such as Teflon IM so as to prevent the residue generated from grinding the portions of the raised objects suctioned into the chamber 210 from sticking to the walls of the chamber. The size and shape of the chamber 210 is not particularly limited so long as the chamber 210 can accommodate the secondary blade 214 and provides sufficient volume to suction and grind the cut portions of the raised objects 250. In some embodiments, the chamber 210 has an opening 218 to enable disposition of the residue. The opening 218 may be closable in some embodiments.

In some embodiments, the machine may further include a grate 220 disposed between the cutter 232 and the chamber 210. The grate 220 may be designed to allow the cut portions of the raised objects 250 to pass through to the chamber 210 while blocking other larger objects such as pieces of sticks or pebbles. In some embodiments, the grate 220 may be a sieve.

In some embodiments, the cutter 232 may be a string attached to a rotor coupled to the cutting motor and/or the suction motor 216. In such embodiments, the rotor is designed to provide sufficient rotational velocity to the string to enable the string to cut or shear the raised objects 250 (e.g., blades of grass).

In some embodiments, the cutter 232 may be a hinged disc blade configured to bend upon contact an object more rigid than the raised objects 250. In such embodiments, the machine may be provided with a feedback mechanism that can stop the machine (i.e., the cutting motor, the suction motor and/or the motor coupled to the secondary blade) as an additional risk mitigating feature.

In some embodiments, the machine 200 is an autonomous grounds maintenance vehicle comprising a sensor stack enabling the machine to be operated autonomously. The sensor stack may include sensors configured to sense an environment surrounding the machine. The sensor stack may include sensors such as the primary and secondary sensors 105, 120 described herein.

In some embodiments, the machine may further include a memory and a processor such as the primary and secondary processors 110, 130 described herein. In addition to the functions already described here, the processor may determine an operating path for the machine within an area of interest on the ground. The processor may determine the operating path based on data relating to an obstacle detected in the operating path of the machine using, e.g., the primary and/or secondary sensors 110, 130. In addition, the processor may determine a path avoiding the obstacle while minimizing deviation from the operating path of the machine.

In some embodiments, the machine may include an optical marker (not explicitly shown) disposed to be visible in a top-view image of the machine. The machine may further include a receiver configured to receive, from an image sensor, a top-down image of an area of interest surrounding the machine on the ground. The top-down image includes the top-view image of the machine. In such embodiments, the processor may be configured to distinguish the machine from structural features on the ground based on an image of the optical marker. Based on the top-down image, the processor determines a position and an orientation of the machine and the structural features relative to the ground. From among the structural features, the processor may determine a subset of features classified as obstacles inhibiting an operation of the machine as the machine moves within the area of interest, and an operating path for the machine within the area of interest so as to avoid the obstacles. The processor may then cause the machine to operate along the determined operating path.

In some embodiments, the processor is further configured to determine, based on the top-down image, one or more of: a number of obstacles inhibiting the operation of the machine within the area of interest, a density of the obstacles per unit area within the area of interest, size of the obstacles within the area of interest, a type of the obstacles, and location of the obstacles within the area of interest relative to each other.

In some embodiments, the top-down image may include a three-dimensional geometrically corrected composite map of the property. In some embodiments, the top-down image comprises an optical image, LIDAR data or an image obtained by an ultrasound sensor. In other words, the top-down image may be obtained using an image sensor that generate images using optical signals, microwave or mm-wave signals, ultrasound signals or any other suitable radiation.

In some embodiments, the image sensor is momentarily fixed relative to the ground and located at a height greater than a height of the optical marker relative to the ground. For example, the image sensor may be mounted to a tree, a pole or another structure affixed to the ground. In some embodiments, the image sensor may be mounted to an unmanned aerial vehicle that can hover at a height above the machine.

In summary, the present disclosure provides for an autonomous grounds vehicle machine that includes one or more risk mitigating features for improved safety.

### Further Considerations

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Although the detailed description contains many specifics, these should not be construed as limiting the scope of the subject technology but merely as illustrating different examples and aspects of the subject technology. It should be appreciated that the scope of the subject technology includes other embodiments not discussed in detail above. Various other modifications, changes and variations may be made in the arrangement, operation and details of the method and apparatus of the subject technology disclosed herein without departing from the scope of the present disclosure. In addition, it is not necessary for a device or method to address every problem that is solvable (or possess every advantage that is achievable) by different embodiments of the disclosure in order to be encompassed within the scope of the disclosure. The use herein of “can” and derivatives thereof shall be understood in the sense of “possibly” or “optionally” as opposed to an affirmative capability.

What is claimed is:

1. A machine comprising:
a suction motor configured to generate suction for objects on ground so as to raise the objects through a cutting plane above and separated from the ground;
a flexible cutter configured to cut and/or shear the raised objects along the cutting plane, wherein the cutter is coupled to a cutting motor separate from the suction motor;
a housing configured to cover the cutter while exposing the cutter towards the ground to enable cutting of the raised objects; and
a chamber coupled to the housing and disposed above the cutter, the chamber being separated from the cutter and comprising a secondary blade configured to grind portions of the raised objects cut by the cutter into a residue,
wherein the chamber is configured to contain the residue, and
wherein the suction motor is coupled to the housing and the chamber, and disposed such that the suction generated therefrom directs the cut portions of the raised objects into the chamber.

2. The machine of claim 1, further comprising a grate disposed between the cutter and the chamber, and configured to allow the cut portions of the raised objects to pass through to the chamber and block other objects.

3. The machine of claim 1, wherein the secondary blade is coupled to the suction motor.

4. The machine of claim 1, wherein an inner wall of the chamber comprises a non-stick coating to prevent the residue and/or the cut portions of the raised objects from sticking to the inner wall.

5. The machine of claim 1, wherein the cutter comprises a string or a hinged disc blade.

6. The machine of claim 1, further comprising a load sensor configured to measure a current drawn by the cutting motor, and differentiate between a normal load on the cutter and an abnormal load caused by interaction of the cutter with an obstacle.

7. The machine of claim 6, further comprising a switch configured to power off the cutting motor in response to the load sensor sensing an abnormal load.

8. The machine of claim 1, wherein the chamber further comprises an opening to enable disposition of the residue.

9. The machine of claim 1, wherein the objects on the ground comprise grass.

10. The machine of claim 1, wherein the secondary blade comprises a mulching blade.

11. The machine of claim 1, further comprising a sensor stack enabling the machine to be operated autonomously, the sensor stack comprising sensors configured to sense an environment surrounding the machine.

12. The machine of claim 11, further comprising a non-transitory memory coupled to a processor, the non-transitory memory having instructions thereon, the instructions causing the processor to determine an operating path for the machine within an area of interest on the ground.

13. The machine of claim 12, wherein the instructions further cause the processor to:
receive, during an operation of the machine, data relating to an obstacle detected in the operating path of the machine using the sensors; and
determine a path avoiding the obstacle while minimizing deviation from the operating path of the machine.

14. The machine of claim 1, further comprising:
an optical marker disposed to be visible in a top-view image of the machine;
a receiver configured to receive, from an image sensor, a top-down image of an area of interest surrounding the machine on the ground of a property, the top-down image including the top-view image of the machine; and
a processor configured to:
distinguish the machine from structural features on the ground based on an image of the optical marker,
determine, based on the top-down image, a position and an orientation of the machine and the structural features relative to the ground,
determine, among the structural features, a subset of features classified as obstacles inhibiting an operation of the machine as the machine moves within the area of interest,
determine an operating path for the machine within the area of interest so as to avoid the obstacles, and
cause the machine to operate along the determined operating path.

15. The machine of claim 14, wherein the processor is further configured to determine, based on the top-down image, one or more of: a number of obstacles inhibiting the operation of the machine within the area of interest, a density of the obstacles per unit area within the area of interest, size of the obstacles within the area of interest, a type of the obstacles, and location of the obstacles within the area of interest relative to each other.

16. The machine of claim 14, wherein the top-down image comprises a three-dimensional (3D) geometrically corrected composite map of the property.

17. The machine of claim 14, wherein the top-down image comprises at least one of an optical image, LIDAR data, or ultrasound sensor data.

18. The machine of claim 14, wherein the image sensor is momentarily fixed relative to the property and located at a height greater than a height of the optical marker relative to the ground.

19. A machine comprising:
a suction motor configured to generate suction for objects on ground so as to raise the objects through a cutting plane above and separated from the ground;
a flexible cutter configured to cut and/or shear the raised objects along the cutting plane, wherein the cutter is coupled to the suction motor;
a housing configured to cover the cutter while exposing the cutter towards the ground to enable cutting of the raised objects; and
a chamber coupled to the housing and disposed above the cutter, the chamber being separated from the cutter and comprising a secondary blade configured to grind portions of the raised objects cut by the cutter into a residue,
wherein the secondary blade is coupled to the suction motor,
wherein the chamber is configured to contain the residue, and
wherein the suction motor is coupled to the housing and the chamber, and disposed such that the suction generated therefrom directs the cut portions of the raised objects into the chamber.
